(19) United States
(12) Patent Application Publication
(10) Pub. No.: US 2017/0361286 A1
(43) Pub. Date: Dec. 21, 2017

(54) MULTIPHASE DEVICE AND SYSTEM FOR HEATING, CONDENSING, MIXING, DEAERATING AND PUMPING

(71) Applicant: Robert KREMER, New York, NY (US)

(72) Inventor: Robert KREMER, New York, NY (US)

(21) Appl. No.: 15/534,090

(22) PCT Filed: Dec. 10, 2015
(86) PCT No.: PCT/US2015/064963

§ 371 Date: Jun. 8, 2017

Related U.S. Application Data
(60) Provisional application No. 62/090,311, filed on Dec. 10, 2014.

(51) Int. Cl. B01F 5/04; B01F 3/04

(52) U.S. Cl. CPC B01F 5/0413; B01F 3/0446; B01F 3/04985

(57) ABSTRACT

An energy saving deaerator device includes: a first incoming flow path that generally follows a central axis of the device from a conically shaped inlet having converging sidewalls, to an expansion chamber having diverging sidewalls, to a compression chamber having converging sidewalls, to an outlet, a first entry port of the compression chamber being defined by an outlet of the expansion chamber; a second incoming flow path having sidewalls that converge to form a ring shaped second entry port of the compression chamber, the ring shaped second entry port being disposed around and concentric with the first entry port; and, wherein the first and second incoming flow paths converge at the compression chamber, with both flow paths being directed toward the outlet, to form an outgoing flow path.

### BACKGROUND OF THE INVENTION

The subject matter disclosed herein relates to green (environmentally friendly) thermal, chemical and mechanical engineering and in particular to direct contact reactors, heat exchangers, mixing various gases, vapors and fluids, producing heat, energy recovery, condensing vapors, deaerating and pumping fluids and liquids.

Many utilities in the United States and around the world generate and supply district steam to buildings for space heating, cooling and domestic hot water purposes. The steam condensate is sometimes returned to the steam generating source or discharged to the city sewer system. In order to reduce the condensate temperature from 220 F to about 140 F (the city sewer requirement) the condensate is mixed with cold potable water. Such systems operate with substantial electric, heat and water losses and sewer discharge rate. The lost condensate must be made-up at the power or boiler plants with cold demineralized water treated in typical tray- or spray-type deaerators. In district steam systems with large condensate losses the water make-up rate can reach 100% of the feedwater flow. At these conditions the deaerators cannot provide the large heating, condensing and deaerating capacity. As a result of these conditions the deaerators experience water hammer and deteriorated heating and deaeration performance. This causes intensive corrosion of the power plant equipment and district steam piping.

Thermal deaeration of feedwater is widely used in power and boiler plants for removal of non-condensable gases from condensate such as oxygen and carbon dioxide. Typically the incoming condensate is heated in the deaerator with steam to the saturation temperature corresponding to the deaerator pressure. The non-condensable gases are removed from the deaerator with venting steam. Typically a small portion of condensate lost with steam (about 10%) in the utilization process is compensated with cold demineralized water which is also introduced to the deaerator. The temperature of the mixed condensate and the demineralized water stream entering the deaerator is typically increased in the deaerator by 20 to 40 F. In many district steam systems the condensate is not returned to the steam generating station and must be made-up with large amount of cold demineralized water with temperatures of 50 to 70 F. For the atmospheric pressure deaerator with saturation temperature of 220 F the temperature of the treated water must be increased in the deaerator by 150 to 170 F, causing water hammer conditions, reduction in the deaerator capacity and deterioration in quality of the deaerated feedwater.

Typical solutions to the above described problem are installation of large surface type heat exchangers where the cold demineralized water is heated to a temperature of about 180 to 200 F before entering the deaerator. This system requires large expensive heat exchangers and electric driven pumps. The tubing system of the heat exchangers is also subject to intensive corrosion caused by the released non-condensable gases. Because heat exchangers use indirect heat transfer through surfaces, they become plugged with scaling causing the reduction of heat transfer and efficiency.

Direct contact jet apparatus (JA) are also known and widely used, as Venturi heaters, de-superheaters, steam ejectors, jet exhausters and compressors, jet eductors and jet vacuum pumps. The JA consists of three principal parts: a converging (working) nozzle surrounded by a suction chamber, mixing nozzle and a diffuser. The working (motive) and injected (entrained) streams enter into the mixing nozzle where the velocities are equalized and the pressure of the mixture is increased. From the mixing nozzle the combined stream enters the diffuser where the pressure is further increased. The diffuser is so shaped that it gradually reduces the velocity and converts the energy to the discharge pressure with as little loss as possible. During this process the bubbles containing the non-condensable gases are collapse and the gases are dissolved in the liquid.

Methods for heating of liquid products in a steam-liquid injector are provided in U.S. Pat. Nos. 6,299,343; 5,205,648; 5,275,486; 5,544,961; 5,544,961; and, 4,847,043, for example.

While existing deaerators and deaerating devices may be suitable for their intended purpose, the art of deaerator devices, and systems utilizing the same, may be advanced with a deaerator device as herein disclosed.

### BRIEF DESCRIPTION OF THE INVENTION

An embodiment includes an energy saving deaerator device, having: a first incoming flow path that generally follows a central axis of the device from a conically shaped inlet having converging sidewalls, to an expansion chamber having diverging sidewalls, to a compression chamber having converging sidewalls, to an outlet, a first entry port of the compression chamber being defined by an outlet of the expansion chamber; a second incoming flow path having sidewalls that converge to form a ring shaped second entry port of the compression chamber, the ring shaped second entry port being disposed around and concentric with the first entry port; and, wherein the first and second incoming flow paths converge at the compression chamber, with both flow paths being directed toward the outlet, to form an outgoing flow path.

Another embodiment of the invention includes an energy saving deaerating system, having: a supply of feedwater; a supply of steam; an energy saving deaerator device configured to receive the feedwater and the steam, and deliver single-phase deaerated water at on outlet, the deaerator device according to the foregoing description; and, a receptacle for receiving the single-phase deaerated water.

Another embodiment of the invention includes an energy saving method for producing single-phase deaerated water, the method including: feeding a supply of feedwater to an energy saving deaerator device; feeding a supply of steam to the energy saving deaerator device; wherein the energy saving deaerator device is according to the foregoing description and is productive of the single-phase deaerated water at an outlet; and, delivering the single-phase deaerated water to a user or a storage receptacle.

Another embodiment of the invention includes a system that employs a green (environmentally friendly) deaerator device for mixing fluids, particularly water and condensate, supplied thereto at different temperatures, with gases particularly steam, and causes reaction, fracking, refractory for hydrocarbon processes, heating, condensing, deaeration and pumping at desired temperatures. It can be widely used in new and retrofit applications for fossil and nuclear power plants (including prevention of LOCA (loss of coolant accidents) similar to the Fukushima Daiichi nuclear disaster), boiler plants, production of liquid hydrocarbon for synthetic fuels, conversion of mixtures of carbon monoxide and hydrogen into liquid hydrocarbon (Bergius-Dyus and Fischer-Troesch processes), biogas, various industries, enhanced oil recovery, fracking, asphalt, emulsion and beer production facilities, steel mills and fertilizing plants, coal liquefaction and gasification, environmental processes (high efficient gas and particulate removal, smoke and flue gases cleaning and neutralizing reagents in wet scrubbers by direct contact of pollutants from various gas streams), heat, chemistry, water and chemical recovery and district energy systems.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1A depicts a cross section side view of an energy saving deaerator device through a central axis having one central axial inlet and two side inlets, in accordance with an embodiment of the invention;

FIG. 1B depicts a cross section side view of an energy saving deaerator device through the central axis similar to that depicted in FIG. 1A, but having only one side inlet, in accordance with an embodiment of the invention;

FIG. 2 depicts a schematic illustration of a system that utilizes the deaerator device of FIGS. 1A and 1B, in accordance with an embodiment of the invention;

FIG. 3 depicts an illustration of the system of FIG. 2 installed in an application;

FIG. 4 depicts an illustration of another system that utilizes the deaerator device of FIGS. 1A and 1B in a scrubber application, in accordance with an embodiment of the invention;

FIG. 5 depicts an illustration of another system that utilizes the deaerator device of FIGS. 1A and 1B in a pump application, in accordance with an embodiment of the invention;

FIG. 6 depicts an illustration of a direct connection of the system of FIG. 2 in a heating system application, in accordance with an embodiment of the invention; and

FIG. 7 depicts an illustration of an indirect connection of the system of FIG. 2 in a heating system application, in accordance with an embodiment of the invention.

The detailed description explains embodiments of the invention, together with advantages and features, by way of example with reference to the drawings.

### DETAILED DESCRIPTION OF THE INVENTION

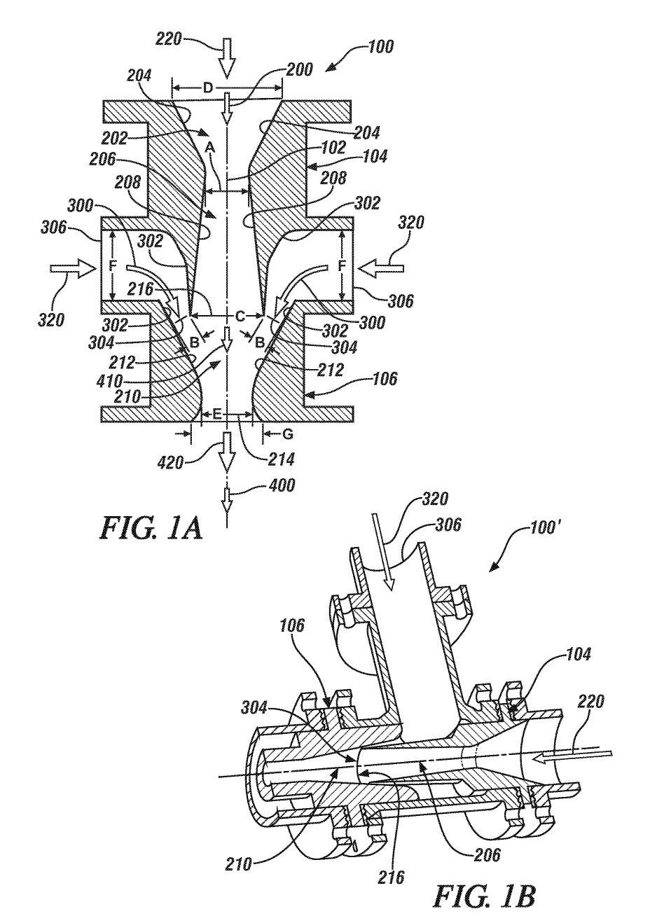

FIG. 1A depicts a cross section side view of energy saving deaerator device 100 through a central axis 102 in accordance with an embodiment of the invention. FIG. 1B depicts a cross section side view of a deaerator device 100′ through the central axis 102 similar to that depicted in FIG. 1A, but with only one side inlet as will be discussed further below. In an embodiment, the deaerator device 100 has a first incoming flow path 200 that generally follows the central axis 102 of the deaerator device 100 from a conically shaped inlet 202 having converging sidewalls 204, to an expansion chamber 206 having diverging sidewalls 208, to a compression chamber 210 having converging sidewalls 212, to an outlet 214, a first entry port 216 of the compression chamber 210 being defined by an outlet having dimension “C” of the expansion chamber 206. The deaerator device 100 further has a second incoming flow path 300 having sidewalls 302 that converge to form a ring shaped second entry port 304 having a dimension “B” of the compression chamber 210, the ring shaped second entry port 304 being disposed around and concentric with the first entry port 216. The first and second incoming flow paths 200, 300 converge at the compression chamber 210, with both flow paths being directed toward the outlet 214, to form an outgoing flow path 400. As depicted in FIG. 1A, the inlet 202 has an entry opening with dimension “D” and the sidewalls 204 converge to a constricted dimension “A”. The expansion chamber 206 expands from the constricted dimension “A” to the dimension “C” of the first entry port 216. The compression chamber 210 converges from a dimension that spans across dimensions “B”, “C”, and “B” again, to a dimension “E” of the outlet 214. The second incoming flow path 300 converges from a dimension “F” at the opening 306 (also herein referred to as an inlet) to the dimension “B” of the ring shaped second entry port 304. In an embodiment, one or more of dimensions “D”, “A”, “C”, “E” and “F” are diameters of a respective circular structure as herein disclosed. In an embodiment, dimension “B” defines a circular ring opening (second entry port 304) disposed around an outer circumference of the first entry port 216 having a circular opening.

In an embodiment, the first entry port 216 (at “C”) is formed via a first housing section 104, and the second entry port 304 (at “B”) is formed via the first housing section 104 being nested within a second housing section 106 (best seen with reference to FIG. 1B).

The first incoming flow path 200 is configured to receive a first flowable medium 220, and the second incoming flow path 300 is configured to receive a second flowable medium 320. In a first embodiment, the first flowable medium 220 comprises steam, and the second flowable medium 320 comprises water. In a second embodiment, the first flowable medium 220 comprises water, and the second flowable medium 320 comprises steam. The flowable medium having the greater flow force is provided to the first incoming flow path 200. As such, in an embodiment, the first flowable medium 220 has a flow force greater than that of the second flowable medium 320.

The first flowable medium 220 and the second flowable medium 320 are combinable at the compression chamber 210 to form a two-phase flowable medium 410, and the compression chamber 210 is configured to compress the two-phase flowable medium 410 so that the outgoing flow path 400 comprises a single-phase deaerated flowable medium 420. In an embodiment, the two-phase flowable medium 410 in the compression chamber 210 comprises water and gas bubbles, and the compression chamber 210 is configured to compress the two-phase flowable medium 410 so that the gas bubbles are condensed and the outgoing flow path 400 comprises single-phase deaerated water (also herein referred to by reference numeral 420). In an embodiment, the two-phase flowable medium 410 in the compression chamber 210 flows at supersonic velocity, and the single-phase deaerated flowable medium 420 in the outgoing flow path 400 external of the deaerator device 100 flows at subsonic velocity. In an embodiment, the first flowable medium 220 has a first flow pressure, the second flowable medium 320 has a second flow pressure, and the single-phase deaerated flowable medium 420 has a third flow pressure that is less than the first flow pressure and less than the second flow pressure. In an embodiment, the first flowable medium 220 is one of feedwater or steam, the second flowable medium 320 is the other of the feedwater or steam, and the single-phase deaerated flowable medium 420 comprises single-phase deaerated water having a temperature greater than that of the feedwater.

While FIG. 1A depicts the deaerator device 100 having one axial conically shaped inlet 202, which may receive steam for example, and two side inlets 306, which may receive cooler feedwater for example, it will be appreciated that an embodiment may have just one side inlet 306, which is discussed further below in connection with FIG. 1B.

The dimensions identified with letters A, B, C, D and E may be determined using the following equation (Eq.-1):

$${P}_{d} = {P}_{w} [ {T}_{w 1} \frac{{f}_{w 1}}{{f}_{3}} + \frac{{K}_{1}}{{ϕ}_{3}} {k}_{w} {T}_{wc} {λ}_{w 1} \frac{{f}_{wc}}{{f}_{3}} - {{k}_{w} ( \frac{2}{{k}_{w} + 1} )}^{{k}_{w} + 1 / {k}_{w} - 1} \frac{{V}_{d}}{{V}_{w}} {( \frac{{f}_{wc}}{{f}_{3}} )}^{2} {( 1 + u )}^{2} ] + ( 1 - \frac{{f}_{wc}}{{f}_{3}} ) {P}_{i}$$

Where, P_{d}=discharged pressure after the device (at 420, FIG. 1); P_{w}=the working gas or steam pressure (at 220, FIG. 1); T_{w1}=Pᵢ/P_{w}, where Pᵢ=injected liquid pressure (at 320, FIG. 1); f_{w1}=cross section of the working nozzle exhaust (“E”, FIG. 1); f₃=cross section of the mixing chamber exhaust (“C”, FIG. 1); K₁=working stream velocity coefficient (at 200, FIG. 1); φ₃=discharge velocity coefficient (at 400, FIG. 1); T_{wc}=P_{c}/P_{w}=ratio of pressure in the critical section of the working nozzle (deaerator device 100) to the working pressure (at “A”, FIG. 1); k_{w}=specific heat of working flow (at 200, FIG. 1); u=injection coefficient equal to the ratio of injected and working flow rates (at 320 and 220, FIG. 1); λ_{w1}=ratio of the velocity of working stream at adiabatic flow to the critical velocity (at “A”, FIG. 1); V_{d} and V_{w}=specific volume of discharged and working flows (at 400 and 200, FIG. 1); f_{wc}=cross section of critical section of the working nozzle (deaerator device 100) (at “A”, FIG. 1).

As used herein, terms such as critical section and critical velocity, refer to the cross section “A” in FIG. 1, and the maximum flow rate at the exhaust (at 400, FIG. 1) that cannot be exceeded with an increased inlet flow rate (at 200, FIG. 1). The K₁ velocity coefficient and the φ₃ velocity coefficient relate to turbulence losses at the inlet and exhaust, and typically have a value less than 1.

In an embodiment, the outlet 214 of the deaerator device 100 has sidewalls that converge internally to the aforementioned dimension “E”, and then diverge to a dimension “G” as the flow exits the deaerator device 100, which serves to further control the rapid pressure drop and expansion of the fluid 420 as it exits the deaerator device 100.

As the fluid 420 expands on exit, a high suction force develops, resulting in the deaerator device 100 acting as a self-feeding suction jet suitable for receiving working fluids (220 for example) and injected fluids (320 for example) over a wide range of pressures, including a vacuum.

Reference is now made back to FIG. 1B, where like elements are numbered alike with respect to FIG. 1A, which more clearly shows the ring shaped second entry port 304 being disposed around and concentric with the first entry port 216, where both entry ports 216, 304 provide entry of the working medium 220 and the injected medium 320 into the compression chamber 210. As seen by comparing the illustration of FIG. 1A with that of FIG. 1B, the ring shaped second entry port 304 has a dimension “B” between the outer periphery of the exit tip (at first entry port 216, dimension “C”) of the expansion chamber 206 and the inner side wall of the housing 106 of the deaerator device 100′. Also depicted in FIG. 1B is a single side entry inlet 306 for receiving an injected medium 320.

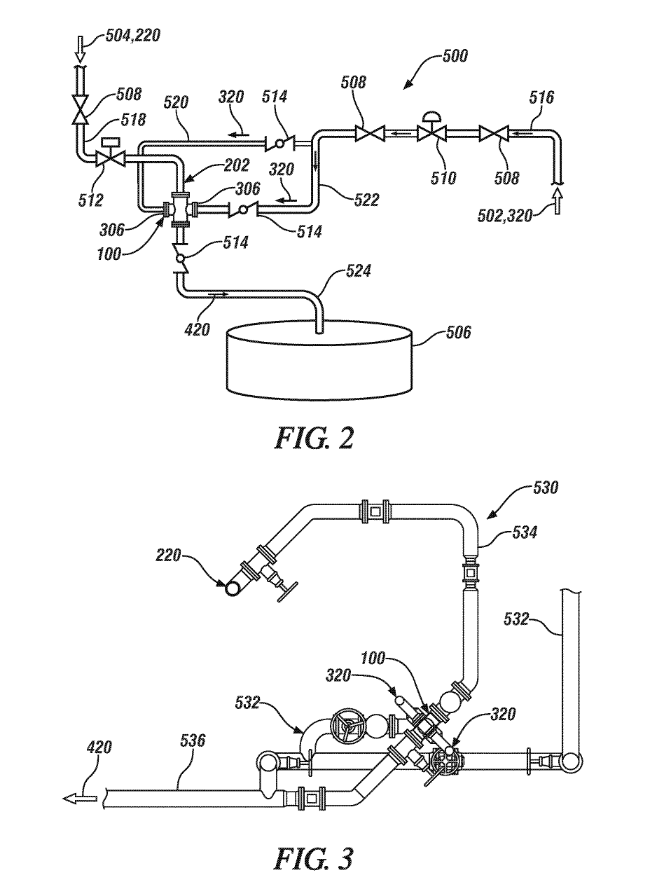

Reference is now made to FIG. 2, which depicts an example energy saving deaerating system 500 that utilizes the deaerator device 100 of FIG. 1A or 1B. In an embodiment, the system 500 generally includes: a supply of feedwater 502 (see 320, FIG. 1A)); a supply of steam 504 (see 220, FIG. 1A); and, the deaerator device 100 configured to receive the feedwater and the steam. In an embodiment, the deaerator device 100 is configured as described above in connection with FIG. 1A or 1B to produce single-phase deaerated water 420. The system 500 further includes a receptacle 506 for receiving the single-phase deaerated water 420. In addition, the system 500 includes a variety of strategically placed one or more valves 508, one or more automatic regulator valves 510, one or more shut off valves 512 (electrically actuated on/off valve for example), and one or more check valves 514, all interconnected via feed lines 516, 518, 520, 522 and 524. In an embodiment, the single-phase deaerated water 420 has a temperature greater than that of the feedwater 502.

The system 500 of FIG. 2 demonstrates that the feed water (cold demineralized water) 320 enters into the deaerator device 100 through two side inlets 306, and steam 220 enters at the top conically shaped inlet 202. In the deaerator device 100, the feed water 320 and steam 220 are mixed, heated and deaerated, as described above. The processed mixture of single-phase deaerated water 420 exits the deaerator device 100 and enters the receptacle 506, which itself may be a deaerator but may not be capable of handling the degree of deaeration desired. Hence, the utilization of deaerator device 100 for improved system performance. In the receptacle/deaerator 506, the non-condensable gases are released guarantying the reliable and corrosion free operation of the feed water system and the plant equipment.

FIG. 3 depicts an installation diagram 530 of the deaerator device 100. As depicted, two 6 inch pipes connected to two 12 inch feed lines 532 supply cold demineralized water 320 to the deaerator device 100, and steam 220 is supplied through a 10 inch supply line 534. The deaerated pre-heated water 420 exits through a 10 inch line 536 and is directed into a receptacle/deaerator 506 (see FIG. 2). As depicted, but not enumerated, the system 530 is equipped gate valves, check valves and water control valve, in a manner known in the art.

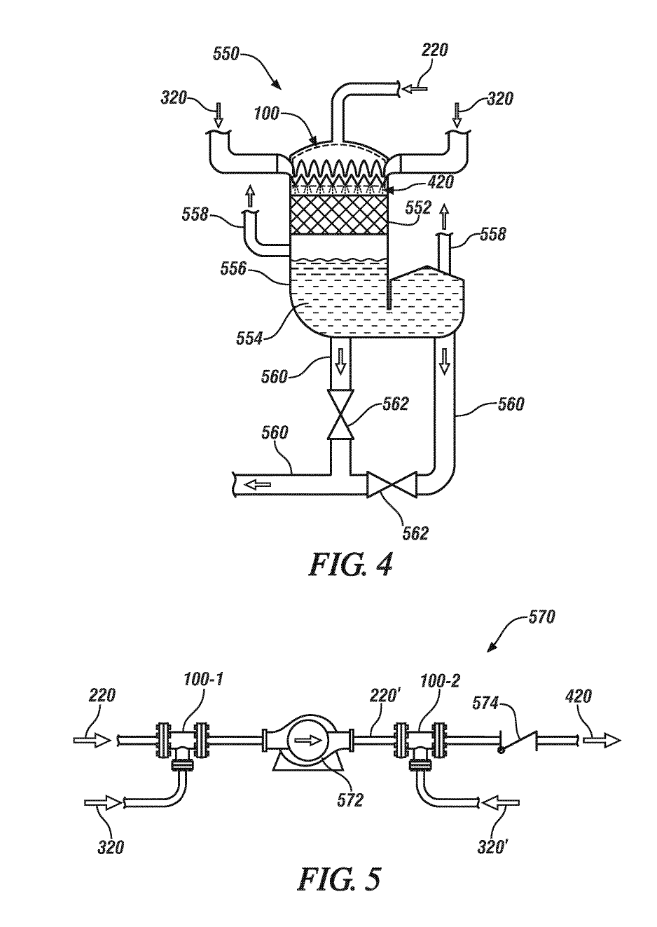

FIG. 4 depicts a schematic of a system 550 utilizing the deaerator device 100 (enclosed within dashed lines) in a heater/scrubber application, which deaerates, heats and scrubs the incoming fluid flows (water 320 and steam/gas 220) and cleans the incoming steam, gas or smoke via the deaerated outlet flow 420. Packing 552 facilitates removal of pollutants/chemicals/contaminants in the steam/gas/smoke 220, which is then fully combined and captured in the water 554 of receptacle 556. Air from the deaeration process is released through air vents 558. Outlet pipes 560 and valves 562 are provided for delivery and post-processing of the water 554. As depicted in FIG. 4, the multi-nozzle deaerator device 100 is located at the upper part of the apparatus of system 550.

FIG. 5 depicts a schematic of a system 570 that utilizes two deaerator devices 100.1, 100.2 with a conventional pump 572 in line with a check valve 574. The first deaerator device 100.1 is connected to the suction side of the pump 572, and the second deaerator device 100.2 is connected to the discharge side of the pump 572. As discussed above, a first fluid flow 220, 220′ and a second fluid flow 320, 320′ are provided to each of the deaerator devices 100.1, 100.2, for a purpose disclosed herein, with an end discharge flow of deaerated water 420. As such, and by deaerating the fluid flow through the pump at both the suction and discharge sides, improved pump performance may be achieved.

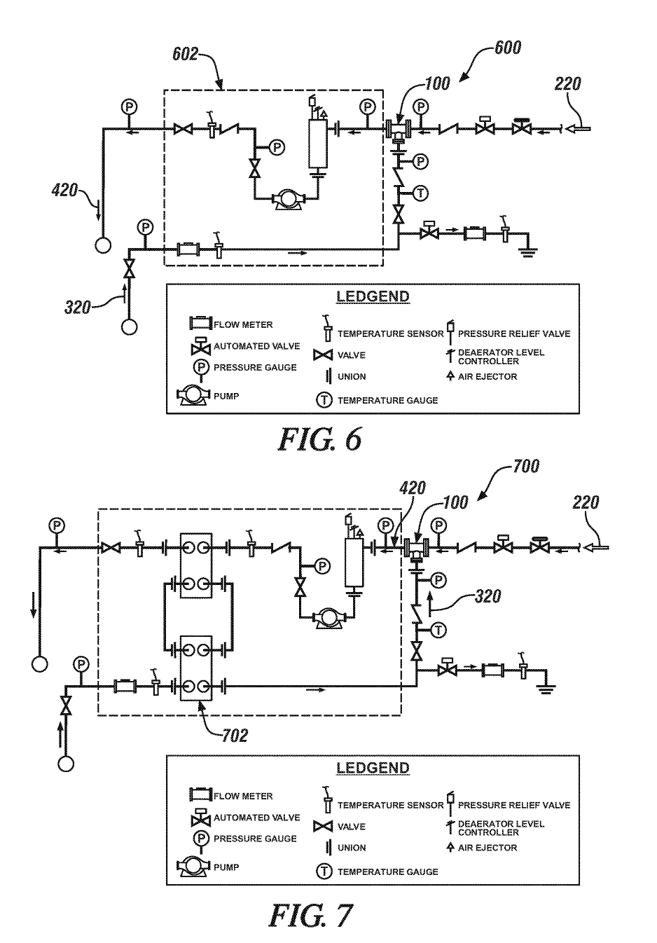

According to another embodiment and with reference now to FIG. 6, an example system 600 that utilizes a deaerator device 100 includes a device which is a green (environmentally friendly) two-phase condensing direct contact heat exchanger 602 with specific internal geometry which causes steam 220 and liquid 320 (including water) to mix, condense and release non-condensable gases, as well as produce deaerated hot water 420. Other components of the system 600 are depicted schematically in FIG. 6 and are identifiable via the Legend.

According to another embodiment and with reference now to FIG. 7, an example system 700 provides advantages over existing indirect heating systems. Indirect heating with conventional heat exchangers are expensive, not energy efficient, and are subject to fouling. The steam heaters foul and scale and need frequent acid cleaning or tube replacement. This reduces productivity and increases maintenance costs. To the contrary, use of a deaerator device 100 as herein disclosed virtually eliminates scaling and fouling by producing deaerated water 420, which also has a self-cleaning capability, that feeds an indirect heat exchanger 702. The deaerator device 100 has no moving parts and low capital and maintenance cost. As depicted in FIG. 7, and various other figures provided herein, the deaerator device 100 is mounted directly into the system piping, freeing up floor space, and can be removed and inspected if necessary. Other components of the system 700 are depicted schematically in FIG. 7 and are identifiable via the Legend.

In an example embodiment, and with reference back to FIG. 2, a deaerator device 100 has the following operational parameters: at 220, the steam input is at 10 bar, 13.81 ton/hr steam; at 200, the inlet dimension “D” is 100 mm; at 102, representative of the passage of steam to the nozzle; at 104, representative of the nozzle housing; at 106, representative of the second stage nozzle housing; at 204, the side wall has an angle of 15-degrees relative to axis 102, at 206, representative of an expanding steam passage; at 208, the side wall of the nozzle has an angle of 8.2-degrees relative to axis 102; at 300, representative of the water inlet to the mixing chamber; at 302, representative of the inlet water supply mixing passage; at 304, representative of the critical section of steam and water becoming inter-reactive; at 210, representative of two-phase fluid mixing and flowing to compression; at 212, representative of compression chamber of two-phase medium at supersonic flow; at 320, representative of water input via a 100 mm diameter pipe, at 100 ton/hr flow at 15 degree-C temperature; nozzle opening dimension “C” is 57.88 mm; at 304, critical opening where water meets steam is 26.43 mm; opening dimension “E” is 37.56 mm; at 400, hot water output is 105 degree-C at 21.58 bar output pressure; at 410, representative of formation of two-phase medium; at 420, representative of single-phase hot water under pressure at 105 degree-C.

Other embodiments of the deaerator device 100 or system utilizing the same will now be described in general terms.

According to an embodiment, the deaerator device 100 when utilized as disclosed herein allows preheating and breaking apart the liquid particles and releasing the non-condensable gases. At the entrance into the deaerator device the non-condensable gases are instantaneously released and removed with a venting steam, and the deaerating performance of the deaerator device is substantially improved allowing the exiting water to reach a desired concentration of oxygen (typically below 7 ppb) and free carbon dioxide level (close to zero).

According to another embodiment, the deaerator device 100 does not have a diffuser and the heating process in the device is completed at the two-phase stage at supersonic speed, at which point all non-condensable gases are released (deaerated) from the liquid and are present in the form of bubbles. The discharged deaerated liquid is then passed to a deaerator where the non-condensable bubbles are flashed out from the liquid and instantaneously removed with the venting steam. The remaining liquid practically contains a very small concentration of non-condensable gases, thus reducing drastically the deaerator duty for their removal. Therefore the final concentration of non-condensable gases in the liquid leaving the deaerator are substantially reduced. As a result the corrosion processes in a boiler are practically eliminated. The deaerator device 100 as herein disclosed also allows to reduce the dimensions and cost of the new downstream deaerators.

According to another embodiment, a system that utilizes a deaerator device 100 allows replacing a surface type heat exchanger with a green in-line two-phase compact direct contact deaerator device 100 where cold water is deaerated and heated with steam, as herein disclosed. During the heating the non-condensable gases are intensively released from the water in the form of micro bubbles. Upon entering a downstream deaerator the non-condensable gases are immediately released and removed from the system with the venting steam, and the deaerating performance is substantially improved allowing the water leaving the downstream deaerator to reach a desired concentration of oxygen (typically below 7 ppb) and free carbon dioxide level (close to zero). This allows to substantially reduce the heating and deaerating capacity of the conventional deaerator, thus reducing the size and cost of the deaerator.

According to another embodiment, cold demineralized make-up fluid of any temperature is introduced into the in-line deaerator device 100 where it is deaerated and heated in direct contact with gases or steam. During the treatment in the device the fluid is broken down to minute particles mixed with bubbles of released non-condensable gases. Upon entering a downstream deaerator the non-condensable gases are immediately released and removed with the venting steam and the deaerating performance is substantially improved allowing the deaerated water to reach a desired concentration of oxygen (typically below 7 ppb) and free carbon dioxide level (close to zero).

According to another embodiment, the deaerator device 100 as disclosed herein allows overcoming the limitation of existing deaerators by substantially increasing the heating and deaerating capability.

In the various systems disclosed herein, gas or steam enters into the deaerator device 100 through a large jet nozzle, inlet 202 for example (see FIG. 1). The cold fluid is supplied by one or multiple side nozzles, inlet 306 for example (FIG. 1). During the mixing described above, the gas or steam condense and transfer heat energy into a lower temperature exhaust fluid (lower temperature than the steam, higher temperature than the cold fluid). The rapid controlled steam condensation allows avoiding water hammer, along with the inherent noise and vibrations in the system. The system runs quiet and vibration free.

In view of all of the foregoing, it will be appreciated that an embodiment of the invention not only includes a deaerator device 100 as herein disclosed, and a system that utilizes the deaerator device, but also includes an energy saving method for producing single-phase deaerated water, which may also be heated in the process, using the deaerator device 100 as herein disclosed. The method generally includes: feeding a supply of feedwater to the deaerator device; feeding a supply of steam to the deaerator device; wherein the deaerator device has structure and performs as herein disclosed to produce single-phase deaerated water; and, delivering the single-phase deaerated water to a user or a storage receptacle, wherein the delivered single-phase deaerated water has a temperature greater than that of the feedwater.

In addition to all of the foregoing, further embodiments of the deaerator device 100 include the following:

Embodiment 1 includes a device in the form of a green (environmentally friendly) two-phase direct contact deaerator device having round, square, triangular, or elliptically shaped gas, liquid, two-phase or steam nozzles for heating, condensing, deaerating and pumping liquids, particularly water.

Embodiment 2 includes the device according to Embodiment 1, further including single or multiple inlets for gas, steam, two-phase fluids or liquids.

Embodiment 3 includes the device according to any of Embodiments 1-2, further including an arrangement where an inlet nozzle, or nozzles are aligned with a mixing nozzle or nozzles.

Embodiment 4 includes the device according to any of Embodiments 1-3, further including a mixing section, or sections where the gas or steam are mixed with liquids at supersonic velocity.

Embodiment 5 includes the device according to any of Embodiments 1-4, further having condensed the gas or steam and heated the liquid to a determined temperature, wherein the non-condensable gases are released from the liquid in the form of bubbles.

Embodiment 6 includes the device according to any of Embodiments 1-5, configured for collecting and pumping condensate from district heating system for generation of heat, electricity and domestic hot water in buildings and industries.

Embodiment 7 includes the device according to any of Embodiments 1-6, further including combining inlet gases, steam, liquids or multi-phase fluids of various pressures up to 600 psig and temperatures up to 700 F.

Embodiment 8 includes the device according to any of Embodiments 1-7, wherein the device is used for heating, condensing and deaerating different streams of gases and liquids.

Embodiment 9 includes the device according to any of Embodiments 1-8, further including providing outlet liquids with defined temperatures.

Embodiment 10 includes the device according to any of Embodiments 1-9, wherein the diameter of inlet gas or steam nozzle is greater than the diameter of the throat of the same nozzle by a factor proportional to the pressure, temperature and quantity parameters.

Embodiment 11 includes the device according to any of Embodiments 1-10, wherein the diameter of the exit gas or steam nozzle is greater than the gap between the exit gas nozzle and the body of the device by a factor proportional to the pressure, temperature and quantity parameters.

Embodiment 12 includes the device according to any of Embodiments 1-11, wherein the diameter of the inlet gas or steam nozzle is 30 percent greater than the diameter of the outlet of the steam or gas nozzle.

Embodiment 13 includes the device according to any of Embodiments 1-12, wherein the diameter of the outlet steam nozzle is equal to the diameter of the two-phase mixture exit from the device.

Embodiment 14 includes the device according to any of Embodiments 1-13, wherein the device is used as a scrubber for heating and cleaning various liquids and gases from particles and smoke.

Embodiment 15 includes the device according to any of Embodiments 1-14, wherein the device is used as a preheater in power plants and boiler rooms.

Embodiment 16 includes the device according to any of Embodiments 1-15, further including an outlet section for a two-phase mixture of liquid and bubbles of non-condensable gases discharged at subsonic velocity, at pressures lower than the pressures of the working and injected flows.

Embodiment 17 includes the device according to any of Embodiments 1-16, wherein the device is used at the inlet and the outlet of a centrifugal pump to prevent cavitation.

Embodiment 18 includes the device according to any of Embodiments 1-17, further including check valves at the inlet and outlet of centrifugal pumps to prevent cavitation.

Embodiment 19 includes the device according to any of Embodiments 1-18, wherein the device is used for cracking heavy crude oil.

Embodiment 20 includes the device according to any of Embodiments 1-19, wherein the device is installed inside of a vessel for mixing with different liquids and gases for heating and deaeration purposes.

Embodiment 21 includes the device according to any of Embodiments 1-20, wherein the device is used for fracking underground wells utilizing cavitation forces.

Embodiment 22 includes the device according to any of Embodiments 1-21, wherein the device is used for enhanced geothermal systems, enhanced oil recovery, or methanol production.

Embodiment 23 includes the device according to any of Embodiments 1-22, wherein the device is used in various chemical processes, food processing, petroleum, dairy, manufacturing, distilling/brewing, desalination, cleaning solutions, pasteurization, sterilization, heating water, waste heat recovery, exchanging heat, degreasing, heating slurries, laundering, cooking, pickling, or quenching and tempering.

Embodiment 24 includes the device according to any of Embodiments 1-23, wherein the device is used in new and retrofit applications for power plants, boiler plants, production of liquid hydrocarbon for synthetic fuels, or conversion of mixtures of carbon monoxide and hydrogen into liquid hydrocarbon (Bergius-Dyus and Fischer-Troesch processes).

Embodiment 25 includes the device according to any of Embodiments 1-24, wherein the device is used in biogas production, beer manufacturing, enhanced oil recovery, asphalt production facilities, steel mills and fertilizing plants, or coal liquefaction and gasification.

Embodiment 26 includes the device according to any of Embodiments 1-25, wherein the device is used in environmental processes: high efficient gas and particulate removal, smoke and flue gases cleaning, or neutralizing reagents in wet scrubbers by direct contact of pollutants from various gas streams.

Embodiment 27 includes the device according to any of Embodiments 1-26, wherein the device is used in various commercial, residential and industrial heating processes, chemicals recovery, or district energy systems.

Embodiment 28 includes the device according to any of Embodiments 1-27, wherein the device is used for deaeration of liquids in a vortex type deaerator to prevent noise during the movement in piping systems in various power systems, commercial, residential and industrial heating processes, or district energy systems.

Embodiment 29 includes the device according to any of Embodiments 1-28; further including an air eliminator in order to remove the non-condensable gases before the liquid enters the deaerator, to be used in various power generation, commercial, residential and industrial heating processes, or district energy systems.

Embodiment 30 includes the device according to any of Embodiments 1-29, wherein the device is used in production of emulsion in various power generation, commercial, residential and industrial heating processes, or district energy systems.

Embodiment 31 includes the device according to any of Embodiments 1-30, wherein the device is used in fossil and nuclear power plants for heating and deaeration of feedwater, or cooling the reactor during a loss of coolant accident (LOCA).

Embodiment 32 includes the device according to any of Embodiments 1-31, further including a transonic device, turbulized vortex gas eliminator/deaerator, control pump, and multifunctional control system, operating as a direct hydraulic loop with the existing heating system.

Embodiment 33 includes the device according to any of Embodiments 1-32, further including a highly turbulized heat exchanger, providing hydraulic separation from the existing heating system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An energy saving deaerator device, comprising:
a first incoming flow path that generally follows a central axis of the device from a conically shaped inlet having converging sidewalls, to an expansion chamber having diverging sidewalls, to a compression chamber having converging sidewalls, to an outlet, a first entry port of the compression chamber being defined by an outlet of the expansion chamber;
a second incoming flow path having sidewalls that converge to form a ring shaped second entry port of the compression chamber, the ring shaped second entry port being disposed around and concentric with the first entry port;
wherein the first and second incoming flow paths converge at the compression chamber, with both flow paths being directed toward the outlet, to form an outgoing flow path.

2. The device of claim 1, wherein:
the first incoming flow path is configured to receive a first flowable medium;
the second incoming flow path is configured to receive a second flowable medium;
the first flowable medium and the second flowable medium are combinable at the compression chamber to form a two-phase flowable medium; and
the compression chamber is configured to compress the two-phase flowable medium so that the outgoing flow path comprises a single-phase deaerated flowable medium.

3. The device of claim 2, wherein:
the first flowable medium comprises steam; and
the second flowable medium comprises water.

4. The device of claim 2, wherein:
the first flowable medium comprises water; and
the second flowable medium comprises steam.

5. The device of claim 2, wherein:
the first flowable medium has a flow force greater than that of the second flowable medium.

6. The device of claim 2, wherein:
the two-phase flowable medium in the compression chamber comprises water and gas bubbles; and
the compression chamber is configured to compress the two-phase flowable medium so that the gas bubbles are condensed and the outgoing flow path comprises single-phase deaerated water.

7. The device of claim 2, wherein:
the two-phase flowable medium in the compression chamber flows at supersonic velocity; and
the single-phase deaerated flowable medium in the outgoing flow path external of the device flows at subsonic velocity.

8. The device of claim 7, wherein:
the first flowable medium has a first flow pressure;
the second flowable medium has a second flow pressure; and
the single-phase deaerated flowable medium has a third flow pressure that is less than the first flow pressure and less than the second flow pressure.

9. The device of claim 2, wherein:
the first flowable medium is one of feedwater or steam;
the second flowable medium is the other of the feedwater or steam;
the single-phase deaerated flowable medium comprises single-phase deaerated water having a temperature greater than that of the feedwater.

10. An energy saving deaerating system, comprising:
a supply of feedwater;
a supply of steam;
an energy saving deaerator device configured to receive the feedwater and the steam;
the energy saving deaerator device comprising:
a first incoming flow path that generally follows a central axis of the device from a conically shaped inlet having converging sidewalls, to an expansion chamber having diverging sidewalls, to a compression chamber having converging sidewalls, to an outlet, a first entry port of the compression chamber being defined by an outlet of the expansion chamber;
the first incoming flow path configured to receive one of the feedwater or the steam;
a second incoming flow path having sidewalls that converge to form a ring shaped second entry port of the compression chamber, the ring shaped second entry port being disposed around and concentric with the first entry port;
the second incoming flow path configured to receive the other of the feedwater or the steam;
wherein the first and the second incoming flow paths converge at the compression chamber, with both flow paths being directed toward the outlet, to form an outgoing flow path;
wherein the feedwater and the steam are combinable at the compression chamber to form a two-phase flowable medium comprising water and gas bubbles;
wherein the compression chamber is configured to compress the two-phase flowable medium so that the gas bubbles are condensed and the outgoing flow path comprises single-phase deaerated water; and
a receptacle for receiving the single-phase deaerated water.

11. The system of claim 10, wherein:
the single-phase deaerated water has a temperature greater than that of the feedwater.

12. The system of claim 10, further comprising:
packing disposed between the deaerator device and the receptacle, the packing being structurally disposed and configured to facilitate removal of pollutants, chemicals, or contaminants in the steam, which is then fully combined and captured in the water of receptacle.

13. The system of claim 10, wherein the deaerator device is a first deaerator device, and further comprising:
a second of the deaerator device; and
a pump;
wherein the first deaerator device is disposed on a suction side of the pump, and the second deaerator device is disposed on a discharge side of the pump.

14. The system of claim 11, further comprising:
a heat exchanger structurally configured and disposed to receive the single-phase deaerated water having a temperature greater than that of the feedwater.

15. An energy saving method for producing single-phase deaerated water, the method comprising:
feeding a supply of feedwater to an energy saving deaerator device;
feeding a supply of steam to the energy saving deaerator device;
wherein the energy saving deaerator device comprises:
a first incoming flow path that generally follows a central axis of the device from a conically shaped inlet having converging sidewalls, to an expansion chamber having diverging sidewalls, to a compression chamber having converging sidewalls, to an outlet, a first entry port of the compression chamber being defined by an outlet of the expansion chamber;
the first incoming flow path configured to receive one of the feedwater or the steam;
a second incoming flow path having sidewalls that converge to form a ring shaped second entry port of the compression chamber, the ring shaped second entry port being disposed around and concentric with the first entry port;
the second incoming flow path configured to receive the other of the feedwater or the steam;
wherein the first and the second incoming flow paths converge at the compression chamber, with both flow paths being directed toward the outlet, to form an outgoing flow path;
wherein the feedwater and the steam are combinable at the compression chamber to form a two-phase flowable medium comprising water and gas bubbles;
wherein the compression chamber is configured to compress the two-phase flowable medium so that the gas bubbles are condensed and the outgoing flow path comprises single-phase deaerated water; and
delivering the single-phase deaerated water to a user or a storage receptacle.

16. The method of claim 15, wherein:
the delivered single-phase deaerated water has a temperature greater than that of the feedwater.
